(19) United States
(12) Patent Application Publication
(10) Pub. No.: US 2024/0410500 A1
(43) Pub. Date: Dec. 12, 2024

(54) PLASTIC PRODUCT AND METHOD OF MOLDING PLASTIC COMPONENT

(71) Applicant: TOYOTA BOSHOKU KABUSHIKI KAISHA, Aichi-ken (JP)

(72) Inventors: Yusuke SUZUKI, Kariya-shi (JP); Ryosuke KATO, Kariya-shi (JP); Tomoe YOSHIMOTO, Aichi-ken (JP)

(73) Assignee: TOYOTA BOSHOKU KABUSHIKI KAISHA, Aichi-ken (JP)

(21) Appl. No.: 18/673,773

(22) Filed: May 24, 2024

(30) Foreign Application Priority Data
Jun. 8, 2023 (JP) 2023-094593

(51) Int. Cl. F16L 9/128; B29C 45/44; F02M 35/10; F02M 35/104; F16L 9/00

(52) U.S. Cl. CPC F16L 9/128; F02M 35/10321; F02M 35/10347; F02M 35/104; F16L 9/003; B29C 45/44; B29C 2045/445

(57) ABSTRACT

A plastic product includes a first component made of plastic and a second component made of plastic. The first component includes a first joint surface. The second component includes a second joint surface joined to the first joint surface. The first component includes a contact surface that is located on a side opposite to the first joint surface in a facing direction. The contact surface includes a general portion and a protruding portion. The first component includes at least one recess in an outer side surface located between the first joint surface and the contact surface in a part in which the protruding portion is provided. The recess opens in the outer side surface.

### CROSS-REFERENCE TO RELATED APPLICATIONS

This application is based upon and claims the benefit of priority from prior Japanese Patent Application No. 2023-094593, filed on Jun. 8, 2023, the entire contents of which are incorporated herein by reference.

### BACKGROUND

### 1. Field

The present disclosure relates to a plastic product and a method of molding a plastic component.

### 2. Description of Related Art

In the related art, a plastic product has been known that includes a first component made of plastic and a second component made of plastic joined to each other.

An example of such a plastic product is an intake manifold for an internal combustion engine disclosed in Japanese Laid-Open Patent Publication No. 2021-25470. The intake manifold disclosed in the above publication includes a surge tank and four branch pipes extending from the surge tank. The intake manifold includes a first component and a second component. The first component includes an upper part of the surge tank and upper parts of the four branch pipes. The second component includes a lower part of the surge tank and lower parts of the four branch pipes. The first component includes a first joint surface. The second component includes a second joint surface joined to the first joint surface. The first component and the second component are formed by injection molding. The first component includes a contact surface that is located on a side opposite to the first joint surface in a direction in which the first component and the second component face each other. When the first component and the second component are joined by the vibration welding method, a jig for restraining the first component comes into contact with the contact surface.

Further, in the related art, there is an intake manifold having projections such as tubular bosses or ribs on the outer surface of the first component.

When the first component is formed by injection molding, a mold is used to inject molten plastic into a cavity. The mold includes a stationary die having a first molding surface that molds an inner surface of the first component, and a movable die provided to be advanced toward and retracted from the stationary die. The movable die molds an outer surface of the first component. The outer surface of the first component may be provided with projections such as bosses or ribs, or the shape of the outer surface may be complicated. In such a case, when the mold is opened, the first component may adhere to the movable die, which is retracted from the stationary die, and thus the demoldability of the first component from the movable die is likely to deteriorate. As a result, it is difficult to remove the first component from the movable die. In this case, if the first component is forcibly removed from the movable die, the first component may be damaged. In addition, applying a mold release agent in order to improve the demoldability of the first component can increase costs.

Furthermore, in a plastic product, there is a demand to increase the joint strength between a first component and a second component. There is also a demand to reduce the amount of plastic used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a plastic article includes a first component made of plastic and a second component made of plastic. The first component includes a first joint surface. The second component includes a second joint surface joined to the first joint surface. A direction in which the first joint surface and the second joint surface face each other is defined as a facing direction. The first component includes a contact surface that is located on a side opposite to the first joint surface in the facing direction and with which a jig for restraining the first component comes into contact when the first component and the second component are joined to each other. The contact surface includes a general portion and a protruding portion that protrudes further in the facing direction than the general portion. The first component includes at least one recess in an outer side surface located between the first joint surface and the contact surface in a part in which the protruding portion is provided, the recess opening in the outer side surface.

In another general aspect, a method of molding the first component that forms the above-described plastic product is provided. The method includes using a mold to inject a molten plastic into a cavity formed by a first molding surface, a second molding surface, and a third molding surface. The mold includes a stationary die, a movable die, and a slide die. The stationary die has the first molding surface. The first molding surface molds an inner surface of the first component. The movable die is provided to be advanced toward and retracted from the stationary die in the facing direction and has the second molding surface. The second molding surface molds a portion of the outer surface of the first component that does not include the at least one recess. The slide die is provided so as to be slide with respect to the stationary die and the movable die. The slide die has the third molding surface. The third molding surface molds a portion of the outer surface of the first component that includes the at least one recess. The method further includes retracting the movable die from the stationary die and the slide die, and retracting the slide die from the stationary die after retracting the movable die.

Other features and aspects will be apparent from the following detailed description, the drawings, and the claims.

### BRIEF DESCRIPTION OF THE DRAWINGS

FIG. 1 is a front view of an intake manifold according to an embodiment.

FIG. 2 is an exploded perspective view of the intake manifold shown in FIG. 1.

FIG. 3 is a plan view of a first component of the intake manifold shown in FIG. 1.

FIG. 4 is a front view of the first component shown in FIG. 3.

FIG. 5 is a bottom view of the first component shown in FIG. 3.

FIG. 6 is a diagram showing a cross-sectional view of the first component taken along line 6-6 of FIG. 4, together with a cross-sectional view of a second component.

FIG. 7 is a diagram showing a cross-sectional view of the first component taken along line 7-7 of FIG. 4, together with a cross-sectional view of the second component.

FIGS. 8A to 8C are cross-sectional views illustrating a method of molding the first component according to the embodiment.

FIG. 9 is a partially enlarged front view of FIG. 1.

FIG. 10 is a partially enlarged perspective view of the first component shown in FIG. 3.

FIG. 11 is a cross-sectional view taken along line 11A-11A of FIG. 10.

FIG. 12 is a partially enlarged perspective view of a first component according to a modification.

FIG. 13 is a cross-sectional view taken along line 13A-13A of FIG. 12.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

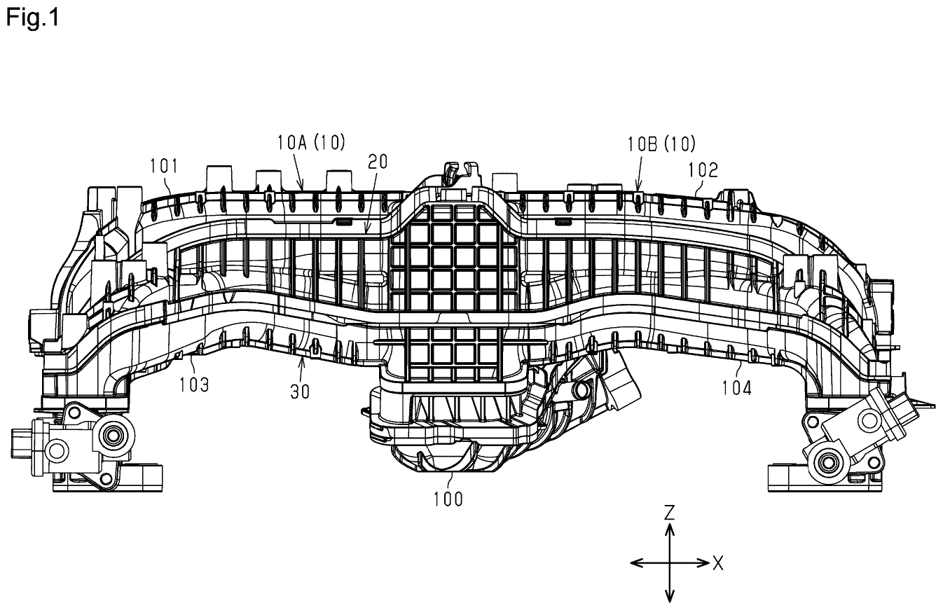

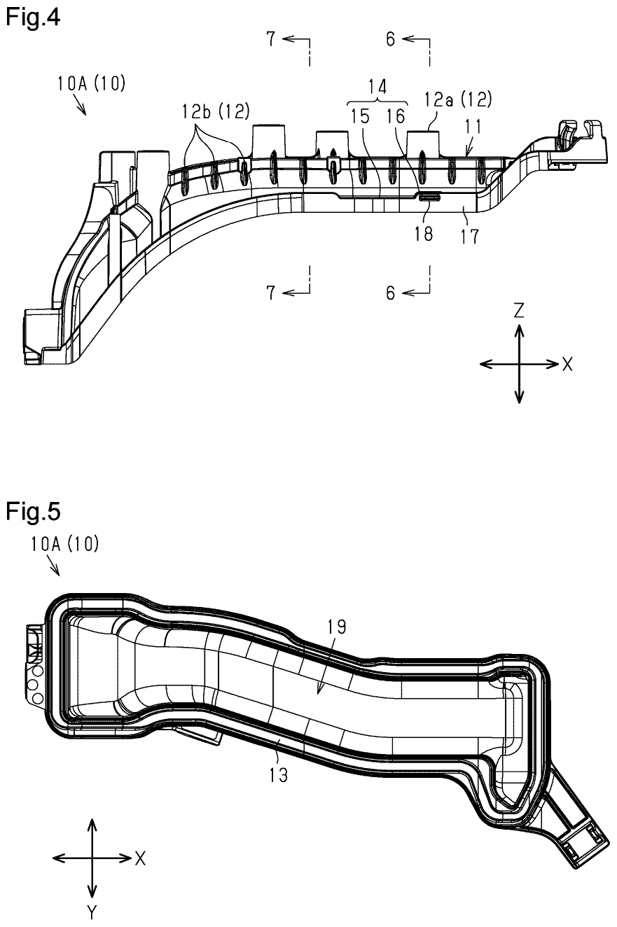

Hereinafter, a plastic product and a method of molding a plastic component according to one embodiment will be described with reference to FIGS. 1 to 9. In the present embodiment, the plastic product is embodied as an intake manifold of an internal combustion engine. Further, the plastic component is embodied as first components 10 forming the intake manifold.

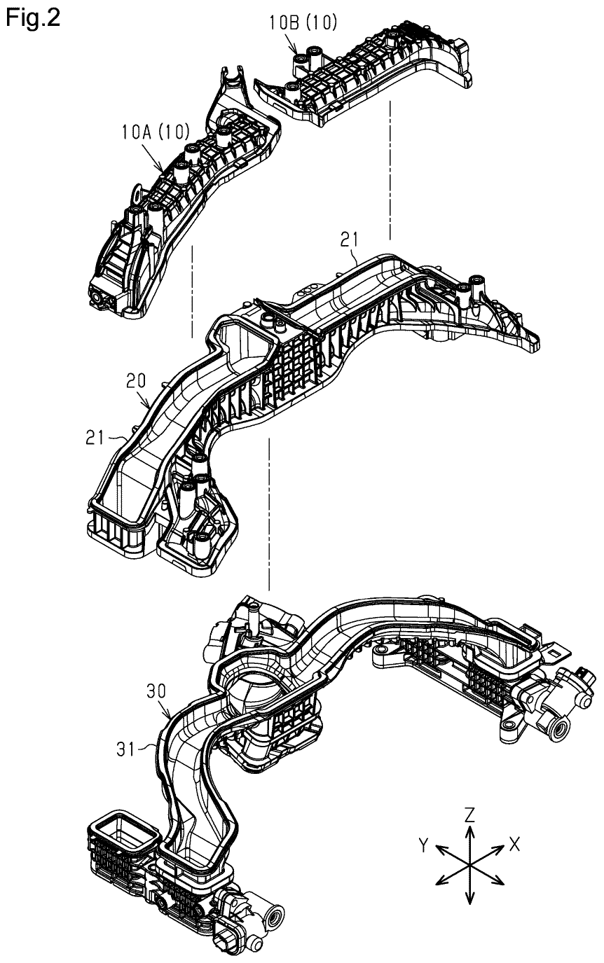

As shown in FIGS. 1 and 2, the intake manifold is provided in an intake passage of an internal combustion engine.

The intake manifold includes a surge tank 100, a first branch pipe 101, a second branch pipe 102, a third branch pipe 103, and a fourth branch pipe 104. The branch pipes 101 to 104 respectively branch from the surge tank 100 and extend.

The first branch pipe 101 and the third branch pipe 103 extend from the surge tank 100 to the left side in FIG. 1, bend, and extend to the lower side in FIG. 1. The third branch pipe 103 is located below the first branch pipe 101 in FIG. 1.

The second branch pipe 102 and the fourth branch pipe 104 extend from the surge tank 100 to the right side in FIG. 1, bend, and extend to the lower side in FIG. 1. The fourth branch pipe 104 is located below the second branch pipe 102 in FIG. 1.

Intake ports (not shown) of the internal combustion engine are respectively connected to the downstream ends of the branch pipes 101 to 104.

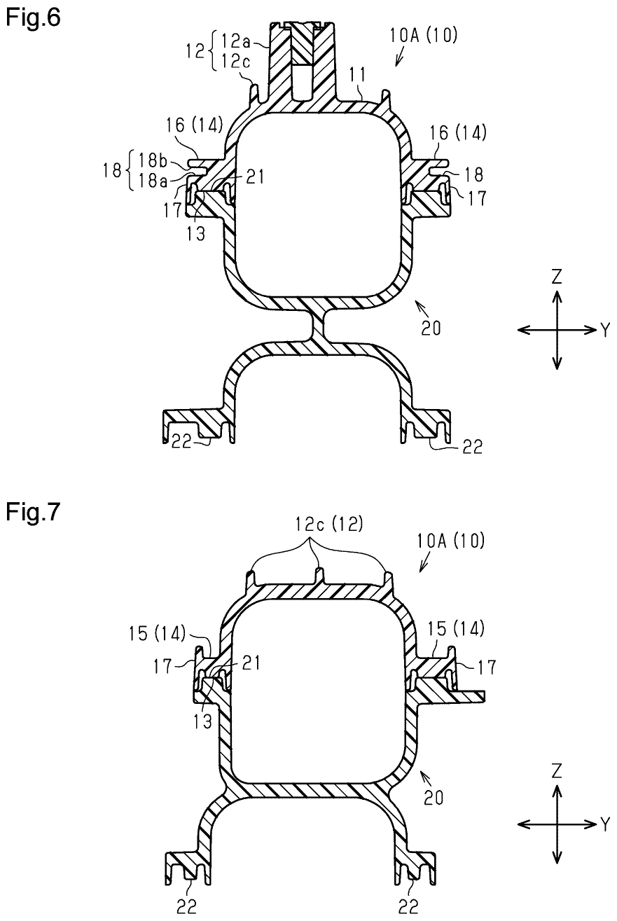

The first branch pipe 101 is formed by a first component 10A and a second component 20, which are both made of plastic. The first component 10A and the second component 20 are half bodies of the first branch pipe 101 (see FIGS. 6 and 7).

The second branch pipe 102 is formed by a first component 10B and the second component 20, which are both made of plastic. The first component 10B and the second component 20 are half bodies of the second branch pipe 102.

The third branch pipe 103 and the fourth branch pipe 104 are both formed by the second component 20 and a third component 30. The second component 20 has a shape in which a half body of the second branch pipe 102 and a half body of the third component 30 are integrated.

The intake manifold basically has a symmetrical shape in the lateral direction of FIG. 1. Therefore, in the following description, the configuration on the left side of FIG. 1 will be described, and the description of the configuration on the right side will be omitted. In addition, the first component 10A will be simply described as a first component 10.

### First Component 10, Second Component 20

As shown in FIG. 5, the first component 10 includes a loop-shaped first joint surface 13.

As shown in FIG. 2, the second component 20 includes a loop-shaped second joint surface 21, which is joined to the first joint surface 13.

Hereinafter, a direction in which the first joint surface 13 and the second joint surface 21 face each other is referred to as a facing direction Z.

As shown in FIGS. 1 to 5, the first component 10 has an elongated shape that is elongated in a longitudinal direction X, which is orthogonal to the facing direction Z.

The first component 10 includes projections 12 on an outer surface 11. The projections 12 include bosses 12a and ribs 12b, 12c.

The bosses 12a are tubular and project in the facing direction Z. In the present embodiment, the bosses 12a are spaced apart from each other in the longitudinal direction X.

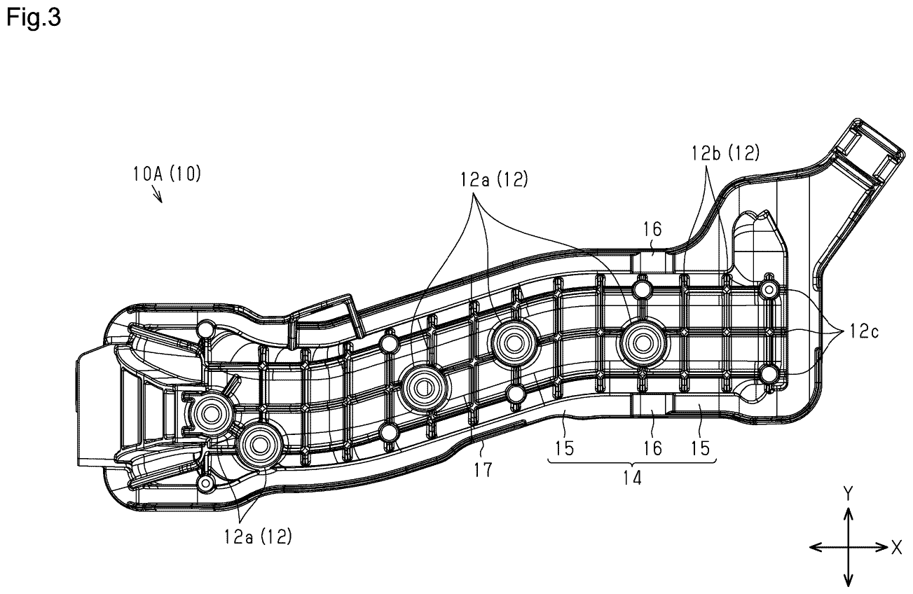

The ribs 12b, 12c project in the facing direction Z. In the present embodiment, the ribs 12b extend in a width direction Y, which is orthogonal to both the facing direction Z and the longitudinal direction X, and are spaced apart from each other in the longitudinal direction X (see FIG. 3). The ribs 12c extend in the longitudinal direction X and are spaced apart from each other in the width direction Y.

As shown in FIGS. 3, 4, 6, and 7, the first component 10 includes a contact surface 14, which is located on a side opposite to the first joint surface 13 in the facing direction Z. The contact surface 14 extends substantially in a loop-shape along the first joint surface 13. The contact surface 14 is a surface with which a jig 90 for restraining the first component 10 comes into contact when the first component 10 and the second component 20 are joined to each other by the vibration welding method. The contact surface 14 includes a general portion 15 and protruding portions 16 that protrude further in the facing direction Z than the general portion 15. Each protruding portion 16 protrudes further in the facing direction Z than the general portion 15 adjacent to the protruding portion 16.

The protruding portions 16 are located on opposite sides in the width direction Y. In the present embodiment, two protruding portions 16 are provided at the same position in the longitudinal direction X. Specifically, the two protruding portions 16 are provided at positions overlapping with one of the bosses 12a in the width direction Y. In the present embodiment, the two protruding portions 16 are provided at positions overlapping with the boss 12a located on the rightmost side in FIG. 3 in the width direction Y.

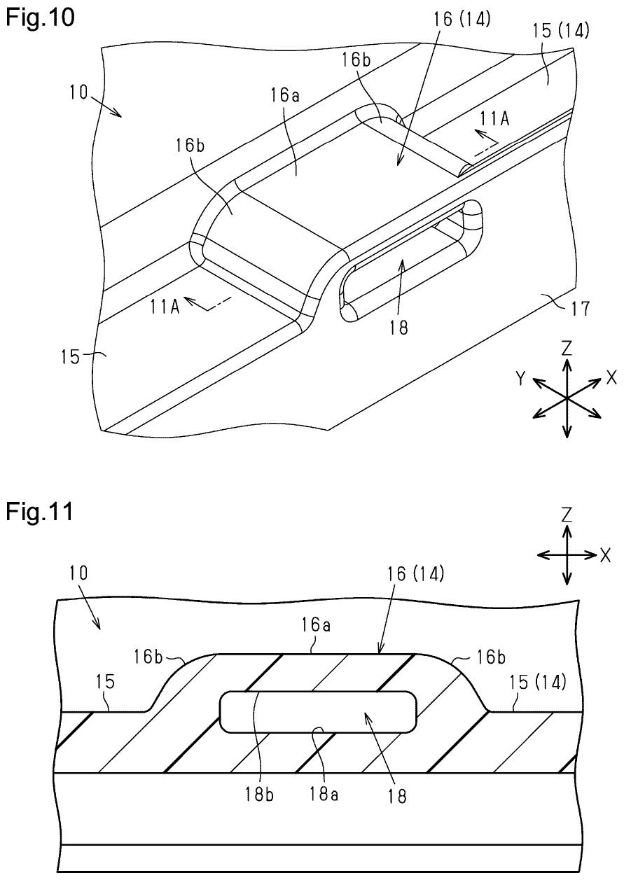

As illustrated in an enlarged manner in FIGS. 10 and 11, each protruding portion 16 extends in the extending direction of the general portion 15 adjacent to the protruding portion 16, that is, in the longitudinal direction X. Specifically, each protruding portion 16 includes a flat protruding end face 16a extending in both the longitudinal direction X and the width direction Y, opposite ends of the protruding end face 16a in the longitudinal direction X, and two side surfaces 16b located between the protruding portion 16 and the adjacent general portion 15. The entire side surface 16b is curved in an arcuate shape from the protruding end face 16a to the general portion 15.

As shown in FIGS. 3, 4, 6, and 7, the first component 10 includes recesses 18 in outer side surfaces 17 between the first joint surface 13 and the contact surface 14. Each recess 18 is located in a part in which the corresponding protruding portion 16 is provided and opens in the corresponding outer side surface 17. That is, the recesses 18 are provided in the outer side surfaces 17, which extend in the longitudinal direction X. The recesses 18 are respectively provided on the outer side surfaces 17 located on opposite sides in the width direction Y. The recesses 18 are provided at positions overlapping with the corresponding boss 12a in the width direction Y. In the present embodiment, two recesses 18 are provided at positions overlapping with the corresponding boss 12a located on the rightmost side in FIG. 3 in the width direction Y.

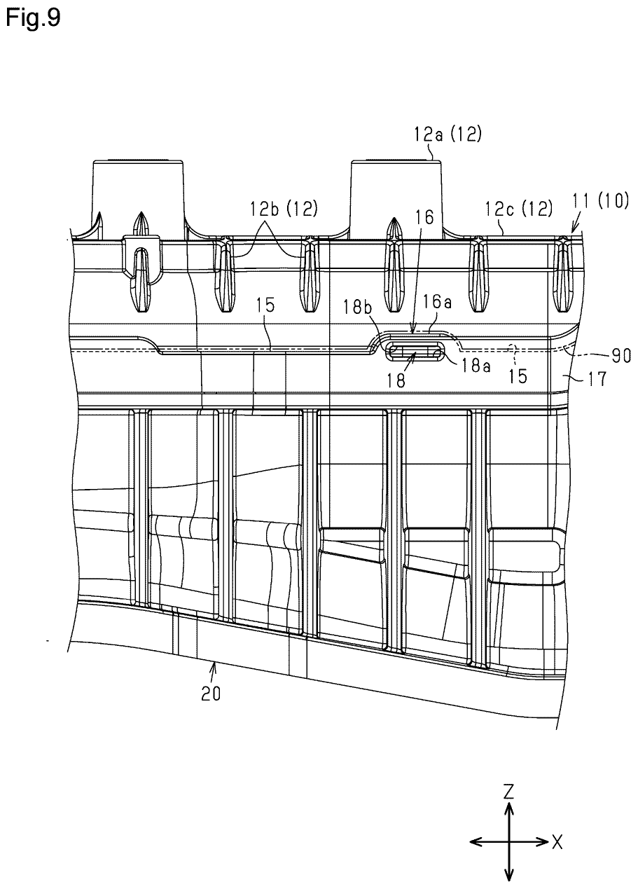

As illustrated in an enlarged manner in FIGS. 9, 10, and 11, each recess 18 extends in the extending direction of the protruding portions 16, that is, in the longitudinal direction X.

Specifically, the cross-sectional shape of the recess 18 orthogonal to the width direction Y is a substantially rectangular shape elongated in the longitudinal direction X. The length of the recess 18 in the longitudinal direction X is smaller than the length of the protruding portion 16 in the longitudinal direction X. The entire recess 18 is located between the opposite ends of the protruding portion 16 in the longitudinal direction X.

As shown in FIGS. 6 and 9, the inner surface of each recess 18 has a flat locking surface 18a and an opposed surface 18b opposed to the locking surface 18a. The locking surface 18a faces away from the second component 20 in the facing direction Z, and extends in both the width direction Y and the longitudinal direction X. The opposed surface 18b is located between the protruding end face 16a of the protruding portion 16 and the general portion 15 adjacent to the protruding portion 16 in the facing direction Z (see FIG. 9).

As shown in FIGS. 6 and 7, the second component 20 includes a joint surface 22, which is joined to a joint surface 31 of the third component 30. The joint surface 22 is provided on a side opposite to the second joint surface 21 in the facing direction Z.

### Third Component 30

As shown in FIG. 2, the third component 30 includes a loop-shaped joint surface 31.

### Method of Molding First Component 10

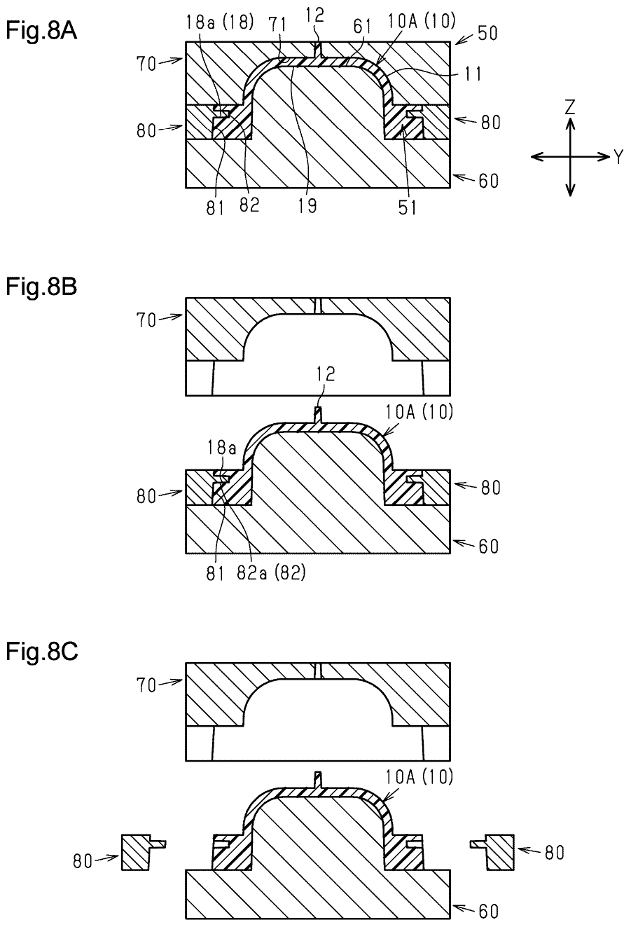

Next, a mold 50 for forming the first component 10 and a method of molding the first component 10 using the mold 50 will be described with reference to FIGS. 8A to 8C.

### Mold 50

As shown in FIG. 8A, the mold 50 includes a stationary die 60, a movable die 70, which is provided to be advanced toward and retracted from the stationary die 60 in the facing direction Z, and slide dies 80, which are provided to slide on the stationary die 60 and the movable die 70.

The stationary die 60 has a first molding surface 61, which molds an inner surface 19 of the first component 10.

The movable die 70 has a second molding surface 71, which molds a portion of an outer surface 11 of the first component 10 that includes the projections 12 and does not include the recesses 18.

The slide dies 80 are provided to be slidable in the width direction Y. The slide dies 80 each has a third molding surface 81, which molds a portion of the outer surface 11 of the first component 10 that includes the corresponding recess 18 and does not include the projections 12. Each third molding surface 81 includes a protrusion 82 that molds the recess 18. The protrusion 82 has a flat portion 82a, which molds the locking surface 18a of the recess 18 (see FIG. 8B).

When the first component 10 is molded, first, a molten plastic is injected from an injection device (not shown) through a runner (not shown) into a cavity 51, which is defined by the first molding surface 61, the second molding surface 71, and the third molding surfaces 81 of the closed mold 50 (injection step).

Subsequently, as shown in FIG. 8B, the movable die 70 is retracted from the stationary die 60 and the slide dies 80 (movable die retracting step).

After the movable die retracting step, the slide dies 80 are retracted from the stationary die 60 as shown in FIG. 8C (slide die retracting step).

Operation of the present embodiment will now be described.

After the movable die 70 is retracted from the stationary die 60 and the slide dies 80, the slide dies 80 are retracted from the stationary die 60. When the movable die 70 is retracted, the protrusions 82 of the third molding surfaces 81 of the slide dies 80 are locked to the recesses 18 of the first component 10. This prevents the projections 12 from adhering to the movable die 70. Accordingly, the first component 10 is readily removed from the movable die 70.

When the first component 10 and the second component 20 are joined to each other by the vibration welding method, if the jig 90 slips on the first component 10, it is difficult to efficiently vibrate the first component 10 by the jig 90. As a result, the amount of friction heat generated between the joint surfaces 13 and 21 is reduced, and thus the joint strength between the first component 10 and the second component 20 is likely to be insufficient. Such a problem is particularly significant when the contact surface 14 of the first component 10 includes numerous curved or inclined surfaces, as shown in FIG. 9.

In this regard, according to the above-described configuration, when the first component 10 and the second component 20 are joined to each other by the vibration welding method, the first component 10 is restrained by the jig 90 by bringing the jig 90 into contact with the contact surface 14 of the first component 10. The contact surface 14 includes the protruding portions 16 that protrude further in the facing direction Z than the general portion 15. Therefore, by engaging the jig 90 with the protruding portions 16, it is possible to limit slipping of the jig 90 on the first component 10 when vibrating the jig 90. Since this allows the first component 10 to be efficiently vibrated, a larger amount of friction heat is generated between the joint surfaces 13 and 21. Therefore, the joint strength between the first component 10 and the second component 20 is increased.

Further, in the above-described configuration, the first component 10 includes the recesses 18 in the outer side surfaces 17, which are located between the first joint surface 13 and the contact surface 14 at parts in which the protruding portions 16 are provided. In the outer side surfaces 17, in which the recesses 18 are provided, the distance between the first joint surface 13 and the contact surface 14 is larger than other portions. This limits the reduction in strength of the first component 10 due to the formation of the recesses 18. In addition, since it is not necessary to increase the amount of plastic in order to limit such reduction in strength, the amount of plastic required for the first component 10 is reduced.

The present embodiment has the following advantages.

(1) The plastic product includes the first component 10 made of plastic and the second component 20 made of plastic. The first component 10 includes the contact surface 14 that is located on the side opposite to the first joint surface 13 in the facing direction Z and with which the jig 90 for restraining the first component 10 comes into contact when the first component 10 and the second component 20 are joined to each other, The contact surface 14 includes the general portion 15 and the protruding portions 16 that protrude further in the facing direction Z than the general portion 15. The first component 10 includes the recesses 18 in the outer side surfaces 17 between the first joint surface 13 and the contact surface 14 in the part in which each protruding portion 16 is provided. Each recess 18 opens in the corresponding outer side surface 17.

This configuration operates in the above-described manner. It is thus possible to increase the demoldability of the first component 10 and to increase the joint strength between the first component 10 and the second component 20. It is also possible to reduce the amount of plastic required for the first component 10.

(2) The first component 10 has an elongated shape that is elongated in the longitudinal direction X. The recesses 18 are provided in the outer side surfaces 17, which extend in the longitudinal direction X.

In this configuration, since the projections 12 are formed on the outer side surfaces 17, which extend in the longitudinal direction X, the recesses 18 can be provided at positions close to the projections 12. This prevents the projections 12 from adhering to the movable die 70. Accordingly, the first component 10 is readily removed from the movable die 70.

(3) The recesses 18 are respectively provided on the outer side surfaces 17 located on the opposite sides in the width direction Y, which is orthogonal to both the facing direction Z and the longitudinal direction X.

With this configuration, when the movable die 70 is retracted, the protrusions 82 of the third molding surfaces 81 of the two slide dies 80 are locked to the two recesses 18 of the first component 10. This prevents the projections 12 from adhering to the movable die 70. Accordingly, the first component 10 is readily removed from the movable die 70.

(4) The projections 12 include the tubular bosses 12a. The recesses 18 are provided at positions overlapping with the corresponding boss 12a in the width direction Y, which is orthogonal to both the facing direction Z and the longitudinal direction X.

With this configuration, the recesses 18 are provided at positions overlapping the corresponding boss 12a in the width direction Y. That is, the recesses 18 are provided at positions near the boss 12a that is likely to adhere to the movable die 70, which is retracted from the stationary die 60 when the mold 50 is opened. This prevents the bosses 12a from adhering to the movable die 70. Accordingly, the first component 10 is readily removed from the movable die 70.

(5) The inner surface of each recess 18 includes the locking surface 18a, which faces away from the second component 20 in the facing direction Z. The locking surface 18a is a flat surface that extends in the width direction Y and the longitudinal direction X.

With this configuration, when the movable die 70 is retracted, the flat portion 82a of the protrusion 82 of the third molding surface 81 of each slide die 80 comes into contact with the corresponding flat locking surface 18a. As a result, when the movable die 70 is retracted, the flat portions 82a of the protrusions 82 are reliably locked to the locking surfaces 18a of the recesses 18. This prevents the projections 12 from adhering to the movable die 70. Accordingly, the first component 10 is readily removed from the movable die 70.

(6) The first component 10 and the second component 20 are half bodies of the branch pipes 101, 102 that form the intake manifold of the internal combustion engine.

The branch pipes 101, 102, which form the intake manifold of the internal combustion engine, are formed by joining two half bodies by vibration welding. These half bodies each include the projections 12 such as the bosses 12a and the ribs 12b, 12c on the outer surface 11. Therefore, when opening the mold 50, there is a tendency for the projections 12 to adhere to the movable die 70 that is retracted from the stationary die 60. This makes it difficult to remove the half body, which is the first component 10, from the movable die 70.

In this regard, the above-described configuration prevents the projections 12 such as the bosses 12a and the ribs 12b, 12c from adhering to the movable die 70. Accordingly, the half body, which is the first component 10, is readily removed from the movable die 70. Also, the above-described configuration limits the reduction in strength of the first component 10 due to the formation of the recesses 18.

(7) The molding method of the first component 10 includes the injection step of using the mold 50 to inject the molten plastic into the cavity 51, which is defined by the first molding surface 61, the second molding surface 71, and the third molding surfaces 81. The molding method of the first component 10 includes the movable die retracting step of retracting the movable die 70 from the stationary die 60 and the slide die 80, and the slide die retracting step of retracting the slide die 80 from the stationary die 60 after the movable die retracting step.

This method achieves an advantage similar to the above-described advantage (1).

### Modifications

The above-described embodiment may be modified as follows. The above-described embodiment and the following modifications can be combined as long as the combined modifications remain technically consistent with each other.

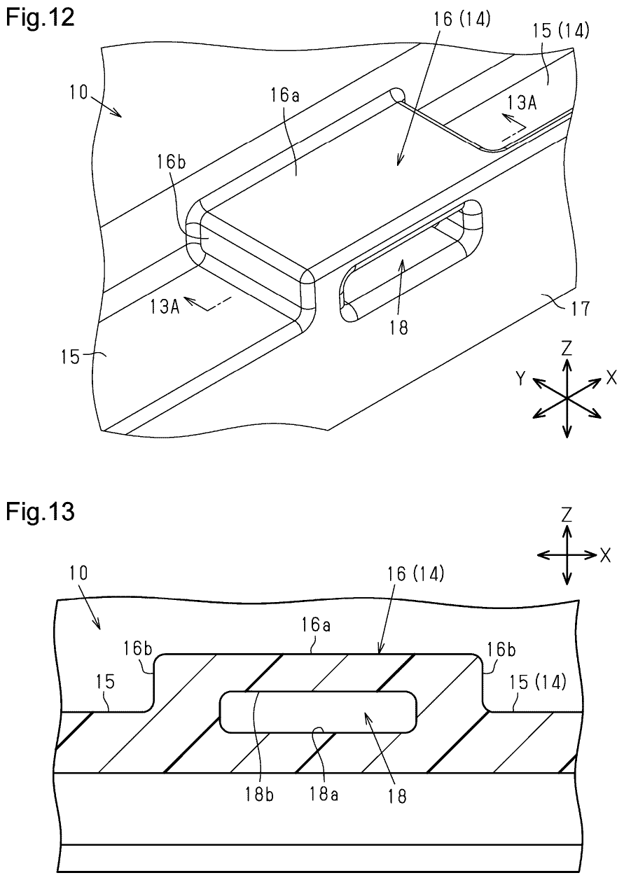

The shape of each protruding portion 16 is not limited to the one exemplified in the above-described embodiment. For example, as shown in FIGS. 12 and 13 in an enlarged manner, a pair of side surfaces 16b may stand upright from the general portion 15 in the facing direction Z. In this case, when the first component 10 and the second component 20 are joined to each other by the vibration welding method, a jig is readily engaged with the protruding portions 16. Therefore, when the jig is vibrated, slipping of the jig on the first component 10 is more reliably prevented.

The locking surfaces 18a are not limited to flat surfaces that extend in the width direction Y and the longitudinal direction X and may be curved surfaces or inclined surfaces.

The cross-sectional shape of the recess 18 orthogonal to the width direction Y may be circular or elliptical.

The recesses 18 may be provided at positions that do not overlap with the corresponding boss 12a in the width direction Y.

The first component 10 does not necessarily need to have the bosses 12a. Further, the first component 10 may lack either the ribs 12b or the ribs 12c.

The recess 18 may be provided only on the outer side surface 17 on one side in the width direction Y.

Multiple recesses 18 may be provided in the longitudinal direction X. In this case, it is preferable to change the number of the protruding portions 16 according to the number of the recesses 18.

The recesses 18 may be provided in the outer side surface 17 located at an end in the longitudinal direction X.

The first component 10 does not necessarily need to have an elongated shape, and may have, for example, a polygonal shape or a circular shape in plan view.

The first component 10 and the second component 20 are not limited to the half bodies of the branch pipes 101, 102 of the intake manifold. For example, the first component and the second component may form another intake pipe such as an inlet duct of the internal combustion engine, or may be embodied as plastic products other than an intake pipe of an internal combustion engine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A plastic article, comprising:
a first component made of plastic; and
a second component made of plastic, wherein
the first component includes a first joint surface,
the second component includes a second joint surface joined to the first joint surface,
a direction in which the first joint surface and the second joint surface face each other is defined as a facing direction,
the first component includes a contact surface that is located on a side opposite to the first joint surface in the facing direction and with which a jig for restraining the first component comes into contact when the first component and the second component are joined to each other,
the contact surface includes a general portion and a protruding portion that protrudes further in the facing direction than the general portion, and
the first component includes at least one recess in an outer side surface located between the first joint surface and the contact surface in a part in which the protruding portion is provided, the recess opening in the outer side surface.

2. The plastic product according to claim 1, wherein
the first component has an elongated shape elongated in a longitudinal direction orthogonal to the facing direction,
the outer side surface includes an outer side surface extending in the longitudinal direction, and
the at least one recess includes a recess provided in the outer side surface extending in the longitudinal direction.

3. The plastic product according to claim 2, wherein
a direction orthogonal to both the facing direction and the longitudinal direction is a width direction,
the outer side surface extending in the longitudinal direction is one of outer side surfaces extending in the longitudinal direction and located on opposite sides in the width direction, and
the at least one recess includes recesses respectively provided in the outer side surfaces located on the opposite sides in the width direction.

4. The plastic product according to claim 2, wherein
the first component includes a projection provided on an outer surface,
the projection includes a tubular boss,
a direction orthogonal to both the facing direction and the longitudinal direction is a width direction, and
the at least one recess includes a recess that is provided in the outer side surface extending in the longitudinal direction and is provided at a position overlapping with the boss in the width direction.

5. The plastic product according to claim 2, wherein
a direction orthogonal to both the facing direction and the longitudinal direction is a width direction,
the at least one recess includes a recess that is provided in the outer side surface extending in the longitudinal direction and includes an inner surface having a flat locking surface, and
the locking surface faces away from the second component in the facing direction and extends in both the width direction and the longitudinal direction.

6. The plastic product according to claim 2, wherein each of the first component and the second component is a half body of a branch pipe that forms an intake manifold of an internal combustion engine.

7. A method of molding the first component that forms the plastic product according to claim 1, the method comprising:
using a mold to inject a molten plastic into a cavity formed by a first molding surface, a second molding surface, and a third molding surface, the mold including:
a stationary die having the first molding surface, the first molding surface molding an inner surface of the first component;
a movable die provided to be advanced toward and retracted from the stationary die in the facing direction and having the second molding surface, the second molding surface molding a portion of the outer surface of the first component that does not include the at least one recess; and
a slide die provided so as to be slide with respect to the stationary die and the movable die, the slide die having the third molding surface, the third molding surface molding a portion of the outer surface of the first component that includes the at least one recess;
retracting the movable die from the stationary die and the slide die; and
retracting the slide die from the stationary die after retracting the movable die.
